(19) United States
(12) Patent Application Publication
(10) Pub. No.: US 2009/0197475 A1
(43) Pub. Date: Aug. 6, 2009

(54) Audio plug and an audio adapter thereof

(75) Inventors: Peter Guo, Tu-Cheng (TW); Chang-Mao Li, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/322,502

(22) Filed: Feb. 2, 2009

(30) Foreign Application Priority Data
Feb. 1, 2008 (CN) 200810018406.7

(51) Int. Cl. H01R 13/502; H01R 13/66

(52) U.S. Cl. 439/688; 439/541.5

(57) ABSTRACT

An audio plug for mounting on a printed circuit board, comprising: an insulative housing; a plurality of contacts, each of them being comparted by the insulative housing, wherein each contact has a front portion for mating with an audio jack and a back portion, said back portion has a plurality of welding portions with flat welding plates for welding the audio plug to the printed circuit board. Welding the PCB with the welding plates instead of welding cable saves the materials and spaces; and the flat welding plates with more area than the traditional audio plug makes the welding easier; the PCB is harder than the cable that makes the audio plug strength.

### BACKGROUND OF THE INVENTION

1. Field of the Invention

The present invention relates to an audio plug, and more particularly to an audio plug welding to a printed circuit board, and an audio adapter including the plug.

2. Description of Prior Art

Consumer electronics always has a data interface, an audio interface and a power interface to transmit the data, the audio signal and the power separately. And these will increase the dimension of said consumer electronics, which against the development trend of miniaturization of the consumer electronics.

Some of the consumer electronics only set one audio jack which can transmit the data and the power, and also can receive the audio plug for audio signal that can reduce the dimension of the consumer electronics.

But connecting with other devices by the audio connector is not widely used on the consumer electronics. So the user needs an adapter to connect the consumer electronics with the audio connector and other devices.

As shown in the Chinese Utility patent ZL200420008904.0, an audio plug is connected with an universal series bus (USB) by four wires, and the user can transmit the data and power with this connector. But the long cable of the connector cost more materials, being easy to knot and needs more spaces to take. However, the cables used thereof increase the cost, and it can easily tied up in addition to it takes more space.

And as the U.S. Pat. No. 6,616,487 issued on Sep. 9, 2003 shown, the wires of the cable are welded on the tail of the audio plug, and a plurality of terminals of the audio plug are arranged densely, so it is difficult to weld the wires to the terminals of the audio plug for the manufacturers and the small area of welding makes the wires are not steadily fixed on the tail of the audio plug and being easy to be detached.

Hence, it is desirable to have an improved audio plug and an adapter with the audio plug to overcome the above-mentioned disadvantages of the prior art.

### BRIEF SUMMARY OF THE INVENTION

Accordingly, the object of the present invention is to provide an audio plug, and more particularly to an audio plug welding to a printed circuit board, and an audio adapter including the plug.

In order to achieve the above-mentioned object, An audio plug for mounting on a printed circuit board, comprising: an insulative housing; a plurality of contacts, each of them being comparted by the insulative housing, wherein each contact has a front portion for mating with an audio jack and a back portion, said back portion has a plurality of welding portions with flat welding plates for welding the audio plug to the printed circuit board.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of an audio adapter with an audio plug in accordance with the present invention.

FIG. 2 is an exploded, perspective view of an audio adapter with an audio plug shown in FIG. 1.

FIG. 3 is a top plan view of an audio adapter but without part of the cover.

FIG. 4 is a perspective view of an audio plug of an embodiment of the present invention.

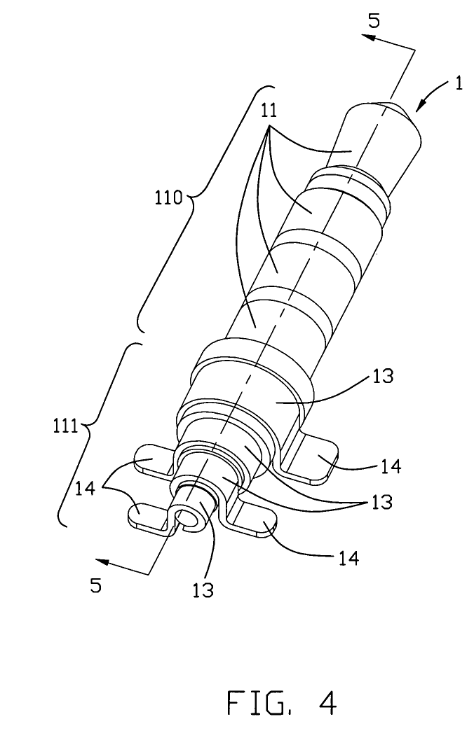

FIG. 5 is a sectional view taken on line 6-6 of FIG. 4.

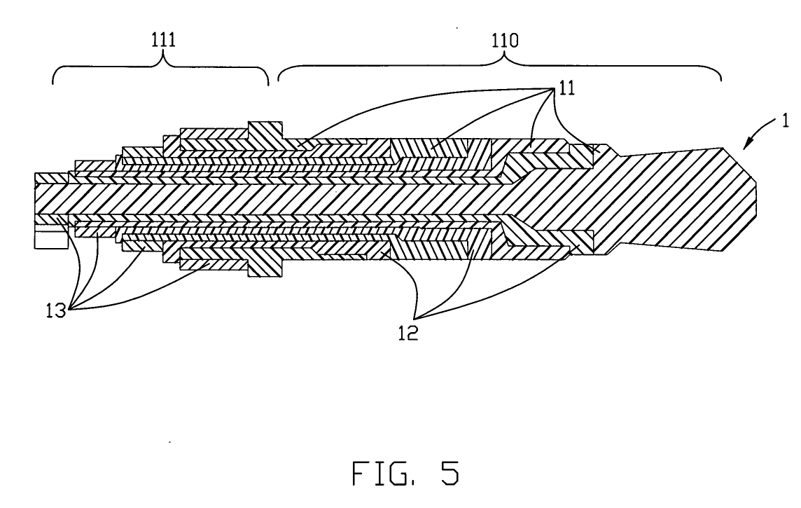

FIG. 6 is an exploded, perspective view of an audio plug of FIG. 4.

### DETAILED DESCRIPTION OF THE INVENTION

Reference will now be made with the drawing figures to describe the present invention in detail.

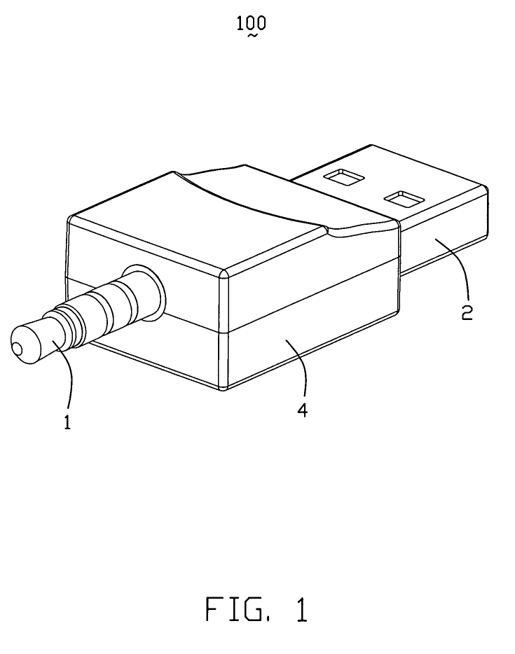

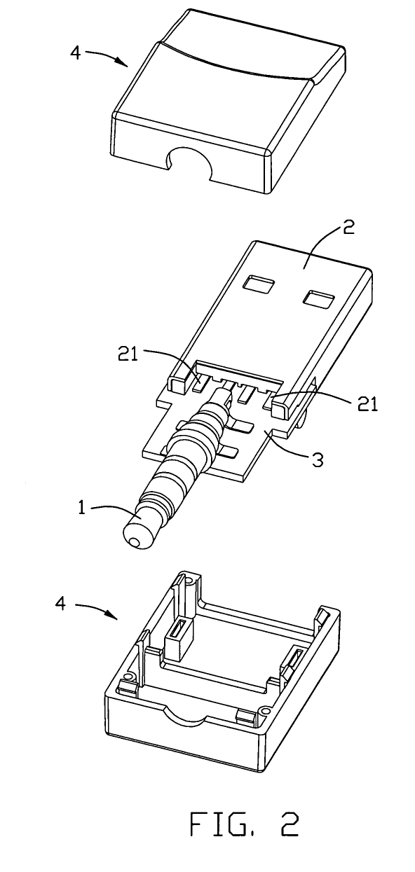

Referring to FIGS. 1-2, an audio adapter 100 with an audio plug 1 in accordance with the present invention comprises an audio plug 1, an adapt connector 2, an printed circuit board (PCB) 3 and cover 4.

Referring to FIGS. 1-2, the adapter connector 2 is an Universal Serial Bus(USB), in other embodiment, the adapter connector can be other connector, such as 1394 interface.

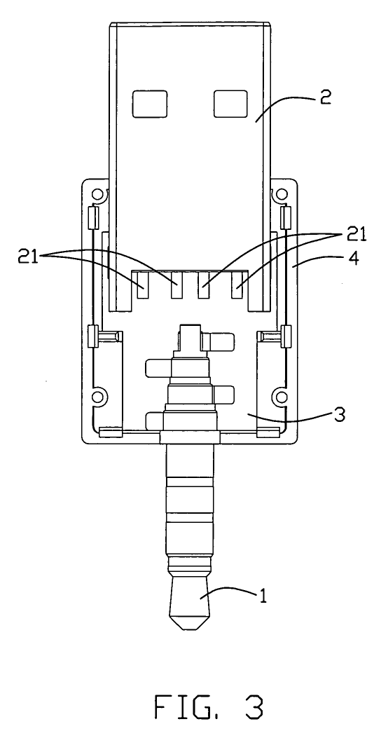

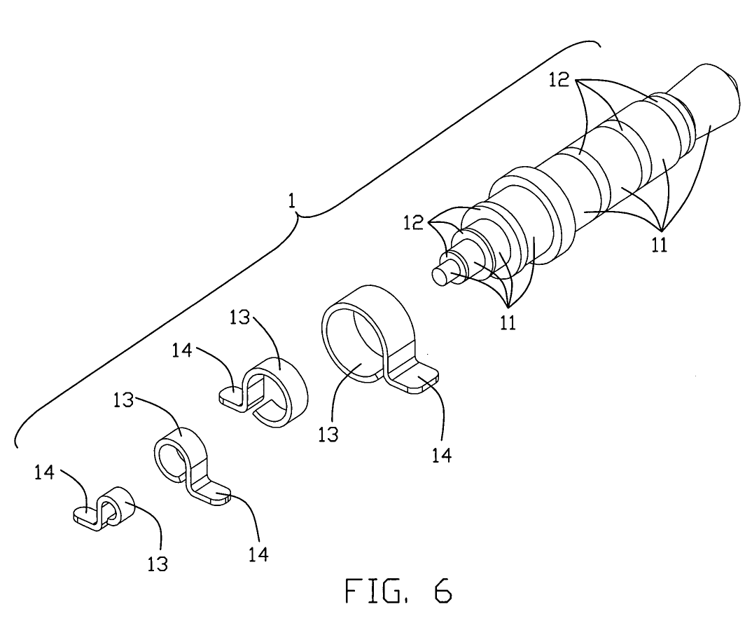

Referring to FIG. 3, the audio plug 1 comprises a plurality of contacts 11. In this embodiment, there are four contacts, and in other embodiment, there are three contacts. Said contacts 11 are comparted by the insulative housing 12, and each of the contacts 11 has a front portion 110 for mating an audio jack, and a back portion 111 for welding the audio plug 1 to the PCB 3. Said front portions 110 and said back portion 111 are round, and the axis of them are along the plug-pull direction of the audio plug 1; four flat welding plates 14 are mechanically and electrically attached on the tail of each back portion 111 to be welded to the PCB 3. the flat welding plates 14 can be attached to the back portion 111 by different ways: the flat welding plates 14 and the back portion 111 are casting forming; welding the flat welding plates 14 to the back portion 111; stamping a circular main portion 13 with a flat welding plate 14(as the FIG. 6 shown), the flat welding plate 14 is extending from one end of the circular main portion 13, and the circular main portion 13 can be sleeved on the back portion 111.

Referring to FIG. 1-3, two ends of the PCB 3 are electrically connecting to the terminals 21 of the adapter connector 2 and the welding plate 14 of the audio plug 1 separately.

An insulative cover 4 is defined on the outside of the audio adapter 100 by insert molding, or the insulative cover can be made first, then being assembled on the outside of the audio adapter.

In present embodiment, two welding plates 14 are on one side of the axis, and the rest of the welding plates 14 are on the other side, that will balance the pull-plug force as the audio plug 1 being pulled or plugged; once all of the welding plates 14 on one side, as the audio plug 1 being pulled or plugged, there is a distance between the pull-plug force which along the axis of the front portions and the welding spot of the welding plates 14, that will make the audio plug 1 deflecting.

In present embodiment, all of the welding plates 14 are on the same plane surface; in the other embodiment, the welding plates 14 can be set on the two sides of the PCB.

In the present invention, welding the PCB with the welding plates instead of welding cable saves the materials and spaces; and the flat welding plate with more area than the traditional audio plug makes the welding easier; the PCB is harder than the cable, that makes the audio plug strength.

We claim:

1. An audio plug for mounting on a printed circuit board, comprising:
an insulative housing;
a plurality of contacts, each of them being comparted by the insulative housing,
wherein each contact has a front portion for mating with an audio jack and a back portion, said back portion has a plurality of welding portions with flat welding plates for welding the audio plug to the printed circuit board.

2. The audio plug as claimed in claim 1, wherein the welding portion and the contacts are integrally formed.

3. The audio plug as claimed in claim 1, wherein the welding portion has a circular main portion, and a flat welding plate is formed on an end of the circular main portion.

4. The audio plug as claimed in claim 3, wherein the circular main portion is sleeving on the back portion of the contact.

5. The audio plug as claimed in claim 1, wherein the welding plates are on the same side of the printed circuit board to welding the audio plug on the printed circuit board.

6. The audio plug as claimed in claim 1, wherein there are three welding plates at least, in one plane, two of them on one side of the axis of the circular main portion, the rest of them on another side.

7. An audio adapter with an audio plug, comprising:
a printed circuit board;
an adapter connector, welding on said printed circuit board;
an audio plug, welding on said printed circuit board, and connecting to the adapter connector electrically, has contacts, each of them is comparted by insulative housing, and the end of the each contact of the audio plug welding to the printed circuit board has a flat welding plate.

8. The audio plug as claimed in claim 7, wherein the welding plates and the contacts are integrally formed.

9. The audio plug as claimed in claim 7, wherein the welding plate are extending from a circular main portion.

10. The audio plug as claimed in claim 9, wherein the circular main portion is sleeved on the back portion of the contact.

11. The audio plug as claimed in claim 7, wherein the welding plates are on the same side of the printed circuit board to fix the audio plug on the printed circuit board.

12. The audio plug as claimed in claim 7, wherein there are three welding plates at least, in one plane, two of them on one side of the axis of the circular main portion, the rest of them on the other side.

13. An electrical connector assembly comprising:
a printed circuit board defining a mounting surface thereon;
a columnar plug formed by a plurality of tubular conductors circumscribing one another with different diameters thereof, respectively; and
said tubular conductors having respective tail sections respectively located at different axial positions along an axial direction and exposed at different levels above the printed circuit board;
said tail sections including extensions extending and soldered to the mounting surface of the printed circuit board; wherein
said extensions have different lengths, in a height direction which is perpendicular to both the axial direction and the mounting surface of the printed circuit board, from one another essentially with a reverse proportion relation with the corresponding diameters.

14. The electrical connector assembly as claimed in claim 13, wherein another connector is mounted on another side of the printed circuit board opposite to said plug.

15. The electrical connector assembly as claimed in claim 13, wherein each of the inner conductors only has one extension soldered to the printed circuit board, and said extensions are alternately arranged with one another along said axial direction.
